(19) United States
(12) Patent Application Publication
(10) Pub. No.: US 2015/0152272 A1
(43) Pub. Date: Jun. 4, 2015

(54) LASER REACTIVE SOLVENT BASED INKS MANUFACTURED FROM MASTERBATCH CONCENTRATES

(71) Applicant: SUN CHEMICAL CORPORATION, Parsippany, NJ (US)

(72) Inventors: Brian Crombie, Wallasey (GB); Peter Salthouse, Knutsford (GB); Thierry Frinault, Congleton (GB); Nick Pagliuca, Leigh (GB); Christine Jayne Juckes, Wigan (GB)

(73) Assignee: SUN CHEMICAL CORPORATION, Parsippany, NJ (US)

(21) Appl. No.: 14/406,808

(22) PCT Filed: Jun. 19, 2013
(86) PCT No.: PCT/US13/46575

§ 371 Date: Dec. 10, 2014

Related U.S. Application Data
(60) Provisional application No. 61/662,636, filed on Jun. 21, 2012.
(60) Provisional application No. 61/752,510, filed on Jan. 15, 2013.

(51) Int. Cl. C09D 11/10; C08K 5/09; C08K 3/22

(52) U.S. Cl. CPC C09D 11/10; C08K 3/22; C08K 5/09

(57) ABSTRACT

The present invention relates to the formulation of masterbatch concentrates for the manufacture of coating/ink compositions for laser imaging substrates, especially flexible substrates primarily used in the packaging industry. The masterbatch concentrates can simply be mixed with different technical varnishes in order to obtain the final physical ink properties as required.

### CROSS-REFERENCE TO RELATED APPLICATIONS

This application claims priority to U.S. Provisional Patent Application No. 61/662,636, filed on Jun. 21, 2012, and U.S. Provisional Patent Application No. 61/752,510, filed on Jan. 15, 2013, which is hereby incorporated herein by reference.

### FIELD OF THE INVENTION

The present invention relates to the formulation of masterbatch concentrates for the manufacture of coating/ink compositions for laser imaging substrates, especially flexible substrates primarily used in the packaging industry. The masterbatch concentrates can be simply mixed with different technical varnishes in order to obtain the final physical ink properties as required.

### BACKGROUND OF THE INVENTION

Most of the prior art for laser sensitive coatings/inks concentrates on water systems. Where solvent systems are disclosed, individual formulations are compared with each other to obtain the desired properties, no laser masterbatch concentrate systems are described.

U.S. Pat. No. 8,105,506 describes coating compositions comprising an oxyanion of a multivalent metal, for example ammonium octamolybdate (AOM), a binder which is typically polymeric, and a solvent such as water or ethanol, and a conductive polymer that absorbs IR radiation. Also listed is the addition of a color former and electron-donating dye precursor. Numerous separate individual formulations are listed.

U.S. Pat. No. 8,101,545 describes coating compositions comprising a color former, an amine salt of an organic metal compound, a binder, a solvent and additional components. A comprehensive list is described together with individual examples.

U.S. Pat. No. 8,101,544 describes compositions comprising a color former, a metal salt of a carboxylic acid, a binder and an organic solvent. Many individual binders are described forming separate examples.

U.S. Pat. No. 8,048,608 B2 describes the use of reduced Indium Tin Oxide (r-ITO) in AOM based ink formulations. The r-ITO is a non-stoichiometric compound; the ITO being reduced bestows NIR absorption properties. Individual ink formulations which are fiber laser reactive are listed.

U.S. Pat. No. 7,485,403 describes how oxyanion-containing compositions are formulated to produce solvent coatings, which can be effectively imaged using a CO₂ laser. The main compound described is ammonium octamolybdate (AOM).

U.S. Pat. No. 7,270,919 describes a process for forming an image on a substrate which comprises coating the substrate with an amine of molybdenum which changes color when subjected to a laser. Numerous individual ink formulations are described.

Substrates produced on production lines, especially for the packaging industry of which paper, board, and polymeric films are examples, are usually marked with information such as logos, bar codes, expiry dates, and batch numbers.

Traditionally, the marking of these substrates has been achieved by various printing techniques for example ink-jet and thermal transfer printing.

More and more, these printing techniques are being replaced by laser marking (aka “laser imaging”), as this method of marking is cheaper in terms of overall economics and also shows performance benefits such as high speed and contact-free marking. Different logos, dates and batch numbers can be easily and readily changed when required.

The substrates to be marked typically have laser markable patches to be imaged. When clear polymeric filmic substrates are to be imaged, these patches can be imaged either from the top surface or from the bottom surface through the film.

The creation of a laser masterbatch concentrate system would be advantageous to end users (printers, manufacturers, etc.) who can quickly and easily blend a technical varnish with a laser masterbatch concentrate to produce finished laser reactive inks for many different applications. The end user has the flexibility to choose from a number of different technical varnishes to impart the necessary performance properties (adhesion, resistance, printability, etc.) for a wide range of printing applications.

### SUMMARY OF THE INVENTION

The present invention provides a laser masterbatch concentrate comprising
a. one or more laser reactive pigment systems;
b. one or more solvents wherein at least one of the solvents is a linear high chain alcohol with at least 3 carbon atoms; and
c. one or more resins,
wherein said laser masterbatch concentrate can be combined with a technical varnish to form a laser reactive solvent-based finished ink.

The present invention also provides a method of preparing a laser masterbatch concentrate comprising combining
a. one or more laser reactive pigment systems;
b. one or more solvents wherein at least one of the solvents is a linear high chain alcohol with at least 3 carbon atoms; and
c. one or more resins,
wherein said laser masterbatch concentrate can be combined with a technical varnish to form a laser reactive solvent-based finished ink.

The present invention also provides a method of preparing a laser reactive solvent-based finished ink comprising combining a masterbatch concentrate with a technical varnish to provide a finished solvent-based laser reactive ink.

The present invention also provides a novel use of polyethylene glycols or polypropylene glycols, preferably with a molecular weight from about 200-8,000 g/mol, as dispersing aids.

The present invention also provides a laser reactive solvent-based ink comprising combining a masterbatch concentrate and a technical varnish.

The present invention also provides a printed article comprising a solvent-based laser reactive ink made from a masterbatch concentrate and a technical varnish.

Other objects and advantages of the present invention will become apparent from the following description and claims.

### DETAILED DESCRIPTION OF THE INVENTION

### Definitions

A laser masterbatch concentrate may be defined as a composition that contains a high wt % of laser reactive pigment(s), preferably at least 38 wt % laser reactive pigment(s), more preferably at least 43 wt % laser reactive pigment(s), even more preferably at least 45 wt % laser reactive pigment(s), and most preferably at least 50 wt % laser reactive pigment(s). The laser masterbatch concentrate would also comprise one or more solvents and one or more resins. While typically not suitable for printing in its own right, the laser masterbatch concentrate would preferably be suitable for blending with a technical varnish to form a finished ink.

A technical varnish may be defined as a solution of a specific resin or blend of resins in solvents, with additives as needed, which is suitable for blending with a laser masterbatch concentrate to provide a laser reactive finished ink that meets end-use customer requirements.

A laser reactive pigment system may be defined as a pigment system that changes color when irradiated with a laser.

Various systems are described. Examples of preferred laser reactive pigments systems are those based on oxyanions, for example ammonium octamolybdate (AOM), and those based on a color former/Leucodye and the salt of a carboxylic acid or other thermal acid generators. All these change color when subjected to the relevant lasers. More specific examples of laser reactive pigment systems, include but are not limited to:

Oxyanion Laser Reactive Pigment Systems—

A preferable oxyanion is ammonium octamolybdate (AOM—(NH₄)₄Mo₈O₂₆). The maximum amount of oxyanion-type laser reactive pigment that would be found in a laser reactive finished ink is typically about 35-40 wt %. However, a more typical range would be 27-37 wt %. In the present invention, the oxyanion-type laser masterbatch concentrates would preferably contain at least 40 wt % laser reactive pigment, more preferably at least 45 wt % laser reactive pigment, and most preferably at least 50 wt % laser reactive pigment. As listed in the examples, a typical range would be 30-80 wt %. Though AOM is preferred, other oyanions will also work, as it is the valency change in the octamolybdate which causes the color change, leaving the cation unchanged. In ammonium octamolybdate the ammonium is the cation and the anion the octamolybdate. A non-limiting list of examples of oxyanions includes molybdate, tungstate, or analogous transition metal compound. Such compounds also include di, hepta, and octa—molybdates and also analogous tungstates. A non-limiting list of examples of cations includes ammonium, an alkali, or an alkali earth metal.

Carboxylic Acid Salt Blocked Acid (or Other Thermal Acid Generators) Laser Reactive Pigment Systems—

Preferred are tri-n-butylammonium borodisalicylate—C₂₆H₃₆BNO₆, Leucodyes (for example 2′-anilino-6′-[ethyl(p-tolyl)amino]-3′-methylspiro[isobenzofuran-1(3H), 9′-[9H]xanthene]-3-one—C₃₆H₃₀N₂O₃). Other examples include Pergascript dyes (from BASF). The amount of laser reactive pigment that would be found in a blocked acid/leucodye laser reactive finished ink would typically be 23-35 wt %. The Carboxylic acid salt-type (or other thermal acid generators)/Leucodye-type masterbatch concentrate of the present invention would preferably contain at least 38 wt % laser reactive pigment, more preferably at least 43 wt % laser reactive pigment, most preferably at least 45 wt % laser reactive pigment, with a typical range being 35-55 wt %. The masterbatch examples 3 & 4 reflect these values.

Oxyanions & Carboxylic Acid Salt Blocked Acid (or other thermal acid generators) Laser Reactive Pigment Systems (as listed above) further containing an infrared heat absorber, e.g. r-ITO (reduced indium tin oxide), Iriotec 8800 & 8825 (from Merck), and others.

All the laser reactive pigments systems described change color when irradiated with a CO₂ laser, while typically only the systems incorporating an IR absorber change color with a fiber laser.

It would also be possible to produce laser masterbatch concentrates, such as by using blends of different laser reactive pigments. In the case of blends, it is preferred that the total amount of laser reactive pigment is at least 38 wt % laser reactive pigment, more preferably at least 43 wt % laser reactive pigment, most preferably at least 45 wt % laser reactive pigment.

Carboxylic acid salt-type laser reactive pigment systems described above are typically considered to be transparent. Oxyanion-type laser reactive pigment systems typically yield a white ink, which turns black with lasering. However, all of the laser reactive pigment system alternatives may be colored without any deterioration to the laser image.

Further examples of Leucodye materials are described and listed in the prior art, and can be incorporated in this way to produce masterbatch concentrates. Such systems include those described in patents US 2012/0045624 A1, U.S. Pat. No. 8,101,545 B2; U.S. Pat. No. 8,101,544, but not only limited to these. A brief summary of these patents are listed in the prior art description.

High chain alcohols may be defined as alcohols having 3 or more carbon atoms. In the present invention, linear high chain alcohols having 3 or more carbon atoms are especially preferred.

Examples of the types of lasers that are typically used in the art of laser marking include but are not limited to CO₂ and fiber lasers.

The present invention refers to the novel concept of the formulation of masterbatch concentrates for the manufacture of coating/ink compositions for laser imaging flexible substrates primarily used in the packaging industry. The masterbatch concentrates can simply be mixed with different technical varnishes in order to produce a finished ink with the final physical properties as required.

The present application also describes the novel use of polyethylene glycols and polypropylene glycols as dispersants in these masterbatch concentrates, and the benefits obtained over conventional dispersants (e.g. Solsperse range obtained from Lubrizol).

The masterbatch concentrate can be combined with numerous technical varnishes to obtain finished coating/ink compositions for laser imaging onto various substrates and end-use applications. One of the main areas of application would be flexible substrates primarily used in the packaging industry, including polymeric types. A partial list of other substrates includes glass, paper, wood, metallics etc., or any other substrate that could be receptive to laser imaging inks.

Inks and coatings made from the masterbatch concentrates can be applied by printing techniques commonly used in the flexible packaging industry, for example flexographic and gravure printing. Conventional solvents used in the printing industry can be used in the formulation of finished inks. The inks made using the masterbatch concentrate concept of the present invention could also be applied using other printing processes (e.g. screen, litho, digital, etc.). When preparing a finished solvent-based laser reactive ink using the masterbatch concentrates of the present invention, it is preferred that the ink formulation contain no more than 90 wt % of the masterbatch concentrate, more preferably no more than 80 wt % of the masterbatch concentrate.

Laser sensitive inks for use with all types of lasers, for example CO₂ laser (9400-10600 nm) and fiber laser (1060-1600 nm) imaging, can be produced using the masterbatch concentrates of the present invention.

For solvent-based laser sensitive printing inks, a masterbatch concentrate can be prepared and subsequently inks with varying properties can easily be made. The masterbatch concentrate preparation is described in detail.

The addition of a dispersing aid (e.g. hyperdispersants such as those supplied by Solsperse but not limited to these) can improve the dispersion by reducing the viscosity and improving the flow, which can reduce the milling time. These hyperdispersants are well known in printing inks, especially for flexible packaging, offering improved pigment dispersion in liquid organic media.

In a preferred embodiment, polyethylene glycols with Mw ranging from 200-8,000 g/mol, more preferably between 200-2,000 g/mol are selected as hyperdispersants as these exhibit good properties as dispersing aids in the manufacture of the masterbatch concentrate. The benefit of these hyperdispersants is that they are easier to disperse, there is a greater availability, and lower cost. Polypropylene glycols of similar molecular weights as above may also be used.

The resin system used in the masterbatch concentrate of the present invention preferably would have a low acid number (0.1-5 mg KOH/g) with a high hydroxyl number (100-350 mg KOH/g) as they tend to be more stable. The resin would also preferably have a glass transition temperature (Tg) between 80°-120° C. This helps enable good milling of the masterbatch concentrate. Examples of resins having these properties are Tego VariPlus SK® (Ketonic Polyol); Laropal® K80 & K1717 HMP (Polyketone); and Laropal® A81 (Aldehyde), but not limited to these. Other resins that can be used include but are not limited to fumaric/rosin adducts, maleic modified rosins, maleic/rosin esters. Trade names for these are Pentalyn®, Unirez®, etc.

Resins with the physical properties described above can help stabilize the pigments used in making the masterbatch concentrates of the present invention.

In a preferred embodiment, by using higher chain alcohols (those with at least 3 carbon atoms), more preferably linear higher chain alcohols, dispersion of the laser reactive pigment systems in the masterbatch concentrate was found to be improved compared to the use of lower chain alcohols and other solvents. Particularly preferred are C₃ linear higher chain alcohols, with n-propanol being an especially preferred material.

When high amounts of lower chain alcohols (C₁ and C₂ alcohols, e.g. ethanol, methanol) are used, this can lead to difficulty in dispersing the laser reactive pigment systems into a masterbatch concentrate. Thus, it is preferred that the lower chain alcohols are kept at a maximum of 10 wt %, more preferably at a maximum of 5 wt %, and most preferably eliminated completely from the masterbatch concentrate formulation.

Other solvents (i.e. those not defined as higher chain linear alcohols, e.g. glycol ethers, acetates, alcohols or ethyl lactate) could also be used in the masterbatch concentrates of the present invention. However it is preferred that use of such solvents would be kept at a maximum of 10 wt %, more preferably at a maximum of 5 wt %, and most preferably eliminated completely from the masterbatch concentrate formulation.

Once the masterbatch concentrate has been prepared, other types of solvents, such as lower chain alcohols, or virtually any other solvent that is compatible with the end-use finished ink product, may be used for dilution and viscosity modifications, either in combination or as single solvents where appropriate.

The masterbatch concentrate approach can be used to provide inks that are sensitive to all lasers, particularly CO₂ and fiber lasers.

The method of using the masterbatch concentrate of the present invention to make laser reactive finished inks can be used either by ink manufacturers or by ink users (printers) who can mix the masterbatch concentrate with the appropriate technical varnish as and when required. When using this masterbatch concentrate method of producing finished inks, good mixing will preferably suffice as the materials that require milling will preferably be pre-milled during the manufacture of the masterbatch concentrate. This gives the user greater ease of use and versatility when printing onto a variety of substrates, e.g. paper/board and various polymeric films. When printing on polymeric films, a recommended adhesion promoter system is described.

In addition to laser reactive pigment systems, the masterbatch concentrates of the present invention or finished inks made from the masterbatch concentrates may be tinted by incorporating traditional colorants. These colorants may be incorporated as color concentrates, flushes, liquid dyes, powders, etc. Suitable colorants include, but are not limited to organic or inorganic pigments and dyes. The dyes include but are not limited to azo dyes, anthraquinone dyes, xanthene dyes, azine dyes, combinations thereof and the like. Organic pigments may be one pigment or a combination of pigments, such as for instance Pigment Yellow Numbers 12, 13, 14, 17, 74, 83, 114, 126, 127, 174, 188; Pigment Red Numbers 2, 22, 23, 48:1, 48:2, 52, 52:1, 53, 57:1, 112, 122, 166, 170, 184, 202, 266, 269; Pigment Orange Numbers 5, 16, 34, 36; Pigment Blue Numbers 15, 15:3, 15:4; Pigment Violet Numbers 3, 23, 27; and/or Pigment Green Number 7. Inorganic pigments may be one of the following non-limiting pigments: iron oxides, titanium dioxides, chromium oxides, ferric ammonium ferrocyanides, ferric oxide blacks, Pigment Black Number 7 and/or Pigment White Numbers 6 and 7. Other organic and inorganic pigments and dyes can also be employed, as well as combinations that achieve the colors desired. If used, it is preferred that traditional colorants be incorporated in relatively small amounts (e.g. less than 10 wt %, more preferably less than 5 wt %).

Adhesion promoters may be used in either the masterbatch concentrate or finished inks made from the masterbatch concentrate. These are described in more detail below. As with most printing inks, other additives, alone or in combination may be employed, including but not limited to, waxes, ammonia, defoamers, dispersants, stabilizers, silicones, rheological modifiers, plasticizers and the like.

As previously discussed, where the masterbatch concentrate is to be used in an ink to be subsequently imaged by a fiber laser, as is common practice, an infrared heat absorber may be incorporated into the formulation. The examples list reduced indium tin oxide (r-ITO), but the IR absorber is not limited to this; many are listed in the prior art. Other IR absorbers are Iriotec 8800 & 8825 (from Merck), and Baytron P (from H C Starck).

It should be noted that for laser reactive pigment systems further containing an IR heat absorber, where the laser is designated a fiber laser, inks produced from these masterbatch concentrates can also be imaged using a CO₂ laser. The laser CO₂ optimum settings in these cases may be different to the settings used in laser reactive pigment systems without an IR heat absorber.

When making finished inks from the masterbatch concentrates of the present invention, preferably there would be no need for further milling, just good mixing should be sufficient.

The addition of an adhesion promoter is preferred when producing finished laser imageable inks for printing onto films or “filmic substrates”. Examples of films include but are not limited to polymeric packaging films (e.g. OPP—orientated polypropylene, polyethylene, PET, polyester, etc.) and coated and/or treated polymeric packaging films (e.g. those coated or treated with acrylic, PVDC, aluminum (Alox), silicone oxide (Silox), nitrocellulose material and its various coatings, etc.).

When used, the adhesion promoter is preferably added when the masterbatch concentrate is blended with the technical varnish to form a finished ink, but adhesion promoter could also be incorporated directly into the masterbatch concentrate. When the finished ink is to be printed on paper/board, adhesion promoter may not be required. One preferred class of adhesion promoters are those based on zirconium propionate, as these materials can help reduce or eliminate undesirable color changes in wet inks based on certain laser reactive pigment systems.

Another preferred class of adhesion promoters are those based on titanium complexes with and without stabilizers. Examples of titanium-based adhesion promoters include but are not limited to Tyzor® range from DuPont, Vertec® range from Johnson Matthey, Tytan® range from Borica. The preferable amount of adhesion promoter added ranges from 0.5 wt % to 25 wt %.

It us understood that the present invention is not limited to the 2 aforementioned classes of adhesion promoters besides. Skilled formulators would be free to choose from a wide range of materials that commonly used as adhesion promoters.

Many finished ink systems, for example those used in flexible packaging by either flexography or gravure printing, may be made by this method, from a masterbatch concentrate.

The masterbatch concentrates of the present invention may also contain thermochromic pigments, preferably irreversible thermochromic pigments. The solvents to be used are determined by the particular thermochromic pigment properties. A range of thermochromic pigments suitable for solvent-based ink systems are obtainable, for example, from Lawrence Industries Ltd (UK).

The following Examples 1-4 exhibit several variations of masterbatch concentrates, but the present invention is not limited to these formulations. One skilled in the art would easily recognize that many other variations are possible and are within the scope of present invention. The masterbatch concentrate examples were dispersed using specific equipment, but it is understood that other typical dispersing equipment could be used (e.g. 3-roll mill, bead mill, high shear mixers, etc.). Each example was dispersed to a preferred grind specification of 10 microns or less.

### Example 1

### Masterbatch Concentrate for Laser Reactive Pigment System 1—CO₂ Laser Image

TABLE 1

| Material | wt % | Typical wt % Range |
|---|---|---|
| N Propanol | 24.4 | 10-60 |
| Hyperdispersant/PEG 1500 | 0.6 | 0.1-5.0 |
| Ammonium octamolybdate | 50.0 | 30-80 |
| Ketone Varnish (Tego VariPlus SK) | 25.0 | 10-40 |
| Total | 100.0 | |

Table 1 shows an example of a masterbatch concentrate which could be blended with a technical varnish to provide a laser reactive finished ink preferably for use with a CO₂ laser. The far right column under the heading “Typical wt % Range” is meant to exemplify general ranges for the materials that could be used to provide variations on Example 1. For Example 1, the laser reactive pigment system can be dispersed using a high shear mixer (e.g. Silverson) or by other typical milling equipment.

### Example 2

### Masterbatch Concentrate for System 2—Fiber Laser Image

TABLE 2

| Material | wt % | Typical wt % Range |
|---|---|---|
| N Propanol | 22.2 | 10-60 |
| Hyperdispersant/PEG 1500 | 0.6 | 0.1-5.0 |
| Ammonium octamolybdate | 50.0 | 30-80 |
| Ketone Varnish (Tego VariPlus SK) | 22.2 | 8-40 |
| IR absorber/r-ITO | 5.0 | 0.1-10 |
| Total | 100.0 | |

Table 2 shows an example of a masterbatch concentrate which could be blended with a technical varnish to provide a laser reactive finished ink preferably for use with a fiber laser. The far right column under the heading “Typical wt % Range” is meant to exemplify general ranges for the materials that could be used to provide variations on Example 2. For Example 2, the laser reactive pigment system can be dispersed using a high shear mixer (e.g. Silverson) or by other typical milling equipment.

### Example 3

### Masterbatch Concentrate for System 3—CO₂ Laser Image

TABLE 3

| Material | wt % | Typical wt % Range |
|---|---|---|
| N Propanol | 30.0 | 10-60 |
| Hyperdispersant/PEG 1500 | 0.6 | 0.1-5.0 |
| Blocked acid (Tri-n-butylammonium | 25.0 | 5-45 |
| borodisalicylate) | | |
| Ketone Varnish (Tego VariPlus SK) | 26.4 | 10-45 |
| Leucodye | 18.0 | 5-30 |
| Total | 100.0 | |

Table 3 shows an example of a masterbatch concentrate which could be blended with a technical varnish to provide a laser reactive finished ink preferably for use with CO₂ lasers. The far right column under the heading “Typical wt % Range” is meant to exemplify general ranges for the materials that could be used to provide variations on Example 3. Example 3 would preferably be made by milling using an Eiger-Torrance 50 ml capacity bead-mill. Other milling equipment could also be used.

### Example 4

### Masterbatch Concentrate for System for System 4—Fiber Laser Image

TABLE 4

| Material | wt % | Typical wt % Range |
|---|---|---|
| N Propanol | 30.0 | 10-60 |
| Hyperdispersant/PEG 1500 | 0.6 | 0.1-5.0 |
| Blocked acid (Tri-n-butylammonium | 22.1 | 5-45 |
| borodisalicylate) | | |
| Ketone Varnish (Tego VariPlus SK) | 26.4 | 10-45 |
| Leucodye | 15.9 | 5-30 |
| IR absorber/r-ITO | 5.0 | 0.1-10 |
| Total | 100.0 | |

Table 4 shows an example of a masterbatch concentrate which could be blended with a technical varnish to provide a laser reactive finished ink preferably for use with a fiber laser. The far right column under the heading “Typical wt % Range” is meant to exemplify general ranges for the materials that could be used to provide variations on Example 4. Example 4 would preferably be made by milling using an Eiger-Torrance 50 ml capacity bead-mill. Other milling equipment could also be used.

The following Examples 5 & 6 exhibit typical laser reactive finished inks that were made by blending a masterbatch concentrate of the present invention with a technical varnish. But the present invention is not limited to these formulations. One skilled m the art would easily recognize that many other variations are possible and are within the scope of present invention.

### Example 5

### Laser Reactive Finished Ink Formulation

TABLE 5

| Material | wt % | Typical wt % Range |
|---|---|---|
| Masterbatch Concentrate | 70 | 10-90 |
| Technical Varnish | 15 | 5-50 |
| Ethanol | 15 | 5-30 |
| Total | 100 | |

Table 5 shows an example of a laser reactive finished ink that was made by blending a masterbatch concentrate of the present invention with a technical varnish. The far right column under the heading “Typical wt % Range” is meant to exemplify general ranges for the materials that could be used to provide variations on Example 5.

### Example 6

### Laser Reactive Finished Ink Formulation

TABLE 6

| Material | wt % | Typical wt % Range |
|---|---|---|
| Masterbatch Concentrate | 40 | 10-90 |
| Colorant/White Pigment | 30 | 0-40 |
| Technical Varnish | 15 | 5-60 |
| Ethanol | 15 | 5-30 |
| Total | 100 | |

Table 6 shows an example of a laser reactive finished ink that was made by blending a masterbatch concentrate of the present invention with a technical varnish. The far right column under the heading “Typical wt % Range” is meant to exemplify general ranges for the materials that could be used to provide variations on Example 6. In Example 6, colorant/white pigment was added by the addition of a concentrate to obtain the desired color. Colorants and/or white pigment would preferably be incorporated as either a pre-dispersed concentrate or in a form that can be dispersed into the finished ink by means of mixing, without the need for milling. However, it would also be possible to incorporate colorants that require milling by adding them and them subjecting the ink to further milling.

All inks produced by the masterbatch concentrate approach can be lasered by the appropriate laser, producing the required images. As previously described, the inks made for the fiber laser can also be laser imaged with a CO₂ laser and vice versa.

Table 7 shows Examples 7-16 which were made to show a partial list of the types of laser reactive finished inks that can be made by blending the masterbatch concentrates of the present invention with various technical varnishes. But this list is by no means exhaustive. Any varnish that is compatible with the masterbatch concentrate could be utilized and depends on the intended end-use application of the ink or coating.

### Examples 7-16

### Laser Reactive Finished Ink Formulations

TABLE 7

| | | | | | Suitable for the | | | | | | | | | |
|---|---|---|---|---|---|---|---|---|---|---|---|---|---|---|
| Technical | Ex. | Formul [symbol] | Substrat [symbol] | | [symbol] | | | | Resistance Properties | | | | | |
| [symbol] | # | Conc/T | Fi | Pap | Flex | Gray | Surfa | Reve | Ta | Scrat | Wrin | Dry | Wet | Oil |
| NC/Polyurethane | 7 | 55/30/15 | ✓ | ✓ | ✓ | ✓ | ✓ | ✓ | 5 | 5 | 5 | 3 | 4 | |
| NC | 8 | 65/15/20 | ✓* | ✓ | ✓ | ✓ | ✓ | ✓ | 5 | 5 | 5 | 3 | 2 | 1 |
| Maleic | 9 | 60/15/25 | | ✓ | ✓ | | ✓ | | — | 4 | — | 3 | — | — |
| PVB | 10 | 60/25/15 | ✓ | | ✓ | ✓ | ✓ | ✓ | 1 | 4 | 3 | 1 | 2 | 2 |
| Polyamide | 11 | 55/30/25 | ✓ | ✓ | ✓ | | | | 5 | 5 | 5 | 1 | 1 | 1 |
| Acrylic | 12 | 70/15/15 | ✓* | ✓ | ✓ | ✓ | | | 5 | 5 | 3 | 4 | 5 | 4 |
| PA/Acrylic | 13 | 75/15/10 | ✓ | ✓ | ✓ | | | | 5 | 5 | 5 | 3 | 4 | 4 |
| Propionate | 14 | 60/25/15 | ✓* | | | ✓ | ✓ | | 5 | 5 | 5 | 3 | 4 | 1 |
| NC/Polyamide | 15 | 60/25/15 | ✓ | ✓ | ✓ | ✓ | ✓ | ✓ | 4 | 4 | 4 | 5 | 5 | 5 |
| NC/Acrylic | 16 | 55/30/15 | ✓* | ✓ | ✓ | ✓ | ✓ | | 5 | 5 | 3 | 3 | 3 | 2 |

¹Ratio of laser masterbatch concentrate (Conc)/technical varnish (TV)/solvent (Sol).
*Adhesion promoter is preferred in formulations for printing on some films to produce optimum adhesion.
Resistance properties test results are expressed as a score from 0 (worst) → 5 (best), 0 being 100% ink removal, 5 being no 0% ink removal or print surface damage. [symbol]
indicates data missing or illegible when filed

Inks in Table 7 were printed using 2 hits of a 140# Anilox roller/blue rubber roller onto typical substrates used in the packaging industry.

### Print Evaluation & Test Methods

The laser reactive finished inks in Table 7 were printed as described above and subjected to a series of resistance tests to exhibit their suitability for various end-use applications. The test results are displayed in Table 7. The test methods used to assess product resistance are as follows:

Tape Adhesion—

Adhesive Tape (Scapa tape—ref: 1112) is stuck on top of a proof print of the ink and is then pulled off. Evaluate level of ink removal. Only tested on films.

Scratch Resistance—

Proof print is laid print-side up on a hard surface and back of index fingernail scratched across surface. Print is evaluated for level of ink removal.

Wrinkle Test—

Grasp proof print with thumb and forefinger at either side of the print, hands approx. 1″ apart, rotate vigorously for 20 cycles to simulate repeated flexing of print. Assess level of ink removal and/or damage to print surface. Only tested on films.

SATRA Dry Rub—

Using a SATRA rub tester (Model STM 461), a dry felt pad (25 mm OD) under a specified load (1.8 Kg) is rotated on the surface of the print for 100 complete cycles. Print is examined for signs of ink removal and/or surface damage.

SATRA Wet Rub—

A water soaked felt pad is placed under the rotating spindle of a SATRA STM 461 tester. Complete 30 cycles and check print for ink removal.

SATRA Oil Rub Test—

As wet rub but with a few drops of vegetable oil placed under dry felt pad.

The present invention has been described in detail, including the preferred embodiments thereof. However, it will be appreciated that those skilled in the art, upon consideration of the present disclosure, may make modifications and/or improvements on this invention that fall within the scope and spirit of the invention.

1. A laser masterbatch concentrate for laser reactive solvent-based inks comprising:
(a) one or more laser reactive pigment systems;
(b) one or more solvents wherein at least one of the solvents is a linear high chain alcohol with at least 3 carbon atoms; and
(c) one or more resins,
wherein said laser masterbatch concentrate can be combined with a technical varnish to form a laser reactive solvent-based finished ink.

2. The masterbatch concentrate of claim 1, wherein the laser reactive pigment system is selected from the group consisting of oxyanions, carboxylic acid salt or other thermal acid generator activated color formers, leucodyes, and thermochromic pigments, or combinations thereof.

3. The masterbatch concentrate of claim 2, wherein the ox anion is ammonium octamolybdate.

4. The masterbatch concentrate of claim 2, wherein the carboxylic acid salt is selected from the group consisting of blocked acid tri-n-butylammonium borodisalicylate and Leucodyes, and combinations thereof.

5. The masterbatch concentrate of claim 1, wherein linear high chain alcohol comprises at least 80% of the total solvent content.

6. The masterbatch concentrate of claim 1, wherein linear high chain alcohol comprises at least 90% of the total solvent content.

7. The masterbatch concentrate of claim 5, wherein the linear high chain alcohol is n-propanol.

8. The masterbatch concentrate of claim 1, wherein the total amount of laser reactive pigment is at least 38 wt %.

9. The masterbatch concentrate of claim 1, wherein the total amount of laser reactive pigment is at least 43 wt %.

10. The masterbatch concentrate of claim 1, wherein the total amount of laser reactive pigment is at least 45 wt %.

11. The masterbatch concentrate of claim 1, wherein the total amount of laser reactive pigment is at least 50 wt %.

12. The masterbatch concentrate of claim 1, wherein the total amount of laser reactive pigment is at least 55 wt %

13. The masterbatch concentrate of claim 1, wherein the laser pigment system further comprises one or more IR heat absorbers.

14. The masterbatch concentrate of claim 13, wherein the IR heat absorber is reduced indium tin oxide.

15. The masterbatch concentrate of claim 1, further comprising a dispersing aid.

16. The masterbatch concentrate of claim 15, wherein the dispersing aid is a polyethylene glycol or a polypropylene glycol with a molecular weight from about 200-8,000 g/mol.

17. The masterbatch concentrate of claim 15 wherein the dispersion aid is a polyethylene glycol or a polypropylene glycol with a molecular weight from about 200-2,000 g/mol.

18. The masterbatch concentrate of claim 1 further comprising one or more additives selected from the group consisting of adhesion promoters, colorants, waxes, defoamers, stabilizers, silicones, theological modifiers, and plasticizers.

19. The masterbatch concentrate of claim 18 wherein the adhesion promoter is a zirconium propionate-type material or a titanium complex-type material.

20. The masterbatch concentrate of claim 1, wherein the one or more resins have an acid number of 0.1-5 mg KOH/g, a hydroxyl number of 100-350 mg KOH/g, and a glass transition temperature of 80-120° C.

21. A method of preparing a laser masterbatch concentrate comprising combining:
(a) one or more laser reactive pigment systems;
(b) one or more solvents wherein at least one of the solvents is a linear high chain alcohol with at least 3 carbon atoms; and
(c) one or more resins,
wherein said laser masterbatch concentrate can be combined with a technical varnish to form a laser reactive solvent-based finished ink.

22. The method of claim 21, wherein the laser reactive pigment system is selected from the group consisting of oxyanions, carboxylic acid salt or other thermal acid generator activated color formers, leucodyes, and irreversible thermochromic pigments.

23. The method of claim 21, wherein linear high chain alcohol is n-propanol.

24. A method of preparing a finished laser reactive solvent-based ink comprising combining the masterbatch concentrate of claim 1 with a technical varnish to provide a finished solvent-based laser reactive ink.

25. A laser reactive solvent-based ink comprising the masterbatch concentrate of claim 1 and a technical varnish.

26. The reactive solvent-based ink of claim 25, wherein the amount of masterbatch concentrate in the ink does not exceed 90 wt %.

27. The reactive solvent-based ink of claim 25, wherein the amount of masterbatch concentrate in the ink does not exceed 80 wt %.

28. The reactive solvent-based ink of claim 25, wherein the amount of masterbatch concentrate in the ink does not exceed 70 wt %.

29. A printed article comprising the ink of claim 24.
